(19) United States
(12) Patent Application Publication
(10) Pub. No.: US 2001/0007108 A1
(43) Pub. Date: Jul. 5, 2001

(54) Method and system for securely managing EEPROM data files

(75) Inventors: Torsten Teich, Sindelfingen (DE); Martin Witzel, Schoenaich (DE)

Correspondence Address: Kevin P. Radigan, Esq., HESLIN & ROTHENBERG, P.C., 5 Columbia Circle, Albany, NY, 12203, US

(73) Assignee: International Business Mechines Corporation, Armonk, NY (US)

(21) Appl. No.: 09/746,489

(22) Filed: Dec. 22, 2000

(30) Foreign Application Priority Data
Dec. 30, 1999 (EP) 99126169.4

(51) Int. Cl. G06F 17/30

(52) U.S. Cl. 707/200

(57) ABSTRACT

Method and system of securely managing EEPROM data files in order to restore data after abortion of a write operation, the data being stored in a record-oriented data structure with each of the records containing a status byte in addition to the data contents.

### PRIOR FOREIGN APPLICATION

This application claims priority from European patent application number 99126169.4, filed Dec. 30, 1999, which is hereby incorporated herein by reference in its entirety.

### TECHNICAL FIELD

This invention generally relates to improvements in the management of data files in non-volatile storage data files and more particularly to the secure management of data files in non-volatile storage memory space of chip cards and other computing devices in case of interrupted write cycles.

### BACKGROUND OF THE INVENTION

Chip cards are becoming more and more wide-spread in various kinds of application fields, such as telephone cards, banking cards, credit cards, ID-cards, insurance cards etc. In addition to the sophisticated identification and authentication mechanisms which they contain, chip cards are often used as data storage devices. In typical processes and operations of chip cards, such as payment operations, authorization processes etc., data stored in the chip card has to be altered. In the following, such processes and operations are called “transactions”.

In a high number of the transactions performed with a chip card, parts of the software contained in the microcontroller of the chip card have to be performed either completely or not at all. A sequence of operations which cannot be split up (and which can therefore only be performed in full or not at all) is called an atomic sequence of operations. Atomic sequences of operations always occur in EEPROM write routines. Atomic sequences are based on the premise that in write cycles of the EEPROM it must be ensured that the concerned data is not only partially written. This can occur, for example, if the user of the chip card withdraws the card from the terminal during the write process, or if there is a power failure. A secure management of the EEPROM write data is particularly essential if the chip card is used as an electronic purse (e-cash) as the chip card has to be a reliable payment device for the user, and because especially in payment transactions, data contained in multiple files has to be altered simultaneously.

In these cases, the operating system of the chip card has to ensure that the consistency of all data is guaranteed when the chip card is energized again after an interrupted write process.

At present, chip cards contain backup buffers in their EEPROMs. Such buffers are large enough to store all necessary and relevant data and comprise a flag indicating the status. The flag can either be set to “data in the buffer valid” or to “data in the buffer invalid”. Additionally, an allocating memory for the destination address and the actual length of the buffer data must be provided. In operation, data in the destination address is copied into the buffer, together with their physical address and length. The flag is set to “data in the buffer valid”. In a next step, the new data is written at the desired address, and the flag is set to “data in the buffer not valid”. When starting up the operating system before the ATR (answer to reset), the flag is checked. In case it is set to “data in the buffer valid”, there is an automatic writing of the data contained in the buffer to the stored same address.

With this mechanism, it is ensured that valid data is contained in the file, and in case of program interruption, the data in the EEPROM of the chip card can be restored.

However, the known method of using a backup buffer has several disadvantages. First, the buffer size has to be at least as large as the data to be buffered, and has to be reserved in the EEPROM of the chip card. As EEPROM space is expensive and has to be available on the card in a sufficient size in order to store all relevant data for the user, the buffer cannot be arbitrarily large. Therefore, the amount and size of the data to be buffered is limited. Second, due to frequent writing and erasing of data, the buffer is subject to high-duty service and therefore excessively stressed/loaded. As the number of write/erase cycles of the EEPROM is limited, there is the risk that data in this important buffer are most likely to become corrupted because of memory degradation. Third, program execution time is prolongated, due to the obligatory write access to the buffer. Under unfavorable conditions, the access can be three times longer compared to direct write access in the EEPROM. This invention also overcomes these drawbacks.

### SUMMARY OF THE INVENTION

Accordingly, it is a primary object of the present invention to overcome the drawbacks mentioned above and to provide a unique method and system for the secure management of data in chip card applications.

These and other objects of the present invention are accomplished by storing the data in logical structures, i.e. in record-oriented data structures. Each of these records contains a status byte in addition to the data contents. The status byte indicates whether this record is the presently valid one or not (primary attribute). Further, the record contains a sequential number (synchronization number), which is used to establish joining with the files to be synchronized (secondary attribute). From the set of files to be synchronized, a primary file is defined whose present record contains the presently valid synchronization number. The other file(s) is (are) designated as secondary file(s).

According to the present invention, a method and system for data management in a chip card EEPROM is provided which secures data even in the case of interruption or abortion of a sequence, such as power failure etc., without the need for a buffer. The invention allows that two or more files of the chip card stay consistent if an interruption occurs while updating the files by storing the information concerning the creation of the consistency together with the data. By this, data security is guaranteed even over sequences of commands. The invention comprises a special data format and a search algorithm to determine the valid file contents and to correct data which is written incompletely due to interruptions or memory errors. The record search algorithm renders a special recovery routine for data contents after an interruption superfluous.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates the structure of a data file according to the subject invention;

FIG. 2 is an illustration of the structure of the logic records contained in a data file in accordance with the subject invention as shown in FIG. 1.

FIGS. 3a and 3b illustrate a sequence flow for an arbitrary number of files 1 to n in accordance with the subject invention.

### BEST MODE FOR CARRYING OUT THE INVENTION

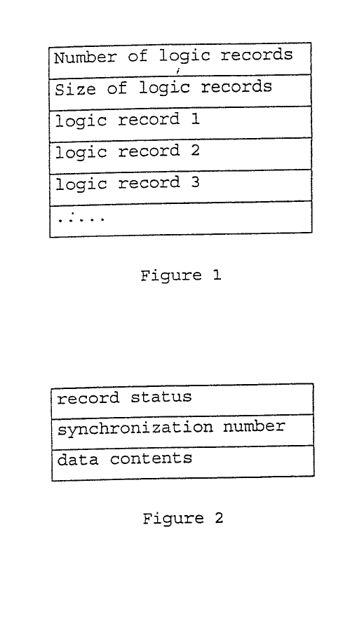

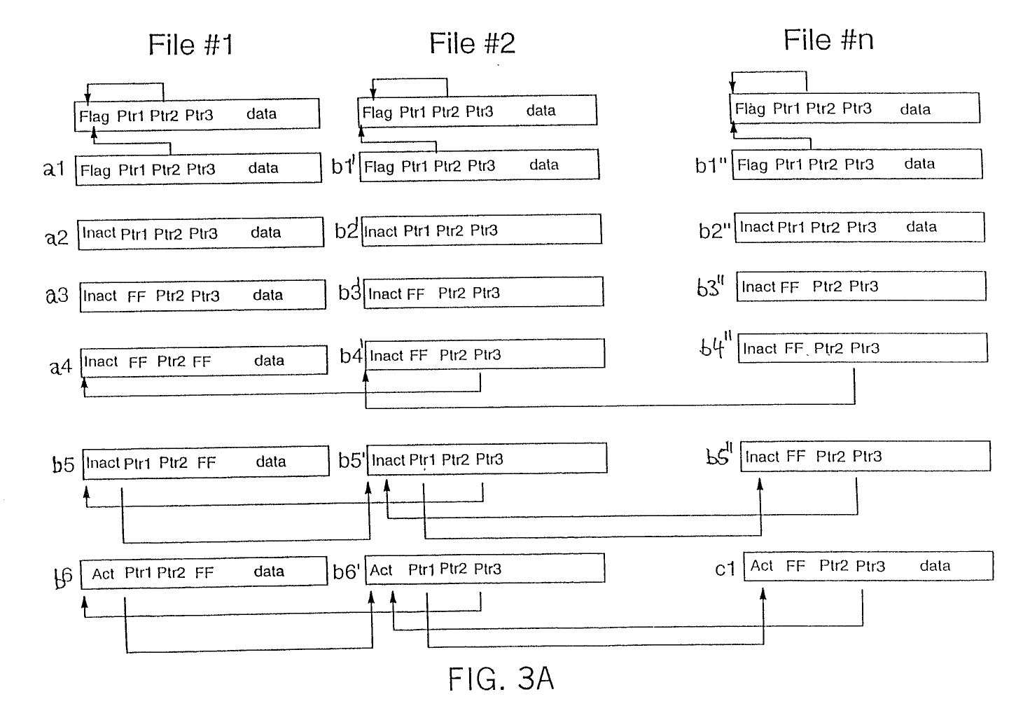

First, the invention is illustrated for the case of two data files affected by a transaction. FIG. 1 shows the structure of each file—primary file and secondary file— according to the invention. FIG. 2 illustrates the structure of each record. According to FIG. 1 each file consists of an indication of the number of logical records, the size of logical records and a consecutively numbered plurality of logical records. Each of those records consists of an indication of the record status, a synchronization number and the data contents, as illustrated in FIG. 2.

When updating files involved in a transaction, the following algorithm is used:

1. determine the current active logical record and the (working) record of the key file to be written;

2. set the synchronization number of the working record of the key file to the synchronization number of the active record, and increase the synchronization number of the present record by 1;

3. write the new data of the key file in the working record;

4. change the record status of the working record of the key file to “active”;

5. . . .

6. execute a complete update of the secondary file, including definition of the new active records;

7 . . .

8. change the record status of the old active record of the key file to “inactive”.

Following this algorithm, it can be ensured for the primary file and the secondary file that new data contents become valid by one single (atomic) write operation on the primary file (step 8 in above algorithm), and that no inconsistent interstages of the data contents occur (steps 5 and 7 in above algorithm are optional steps that can be reserved for additional steps to be performed on the chip card and which are not part of the present invention. The only requirement for this is that the determination of the active logical record and of the working record is performed according to the following record search algorithm for the key file:

1. beginning with the first physical record, search for the first record whose status is “active”;

2. in case the first physical record and the last physical record of the file are marked “active”, then the last physical record is the active one;

3. if there is no record found marked as active, then set the first physical record to “active”;

4. define the physical record following the active one as working record;

5. in case the active record is the last physical record of the file, then the first physical record of the file becomes the working record.

The following is the record search algorithm for the secondary file:

1. beginning with the first physical record, search for the first record whose status is “active”;

2. in case the first physical record and the last physical record of the file are marked “active”, then the last physical record is the active one;

3. if there is no record found marked as active, then set the first physical record to “active”;

4. compare the synchronization number of the determined active record with the synchronization number of the active record of the primary file;

5. if the trial fails, mark the record as “active” whose synchronization number corresponds to the synchronization number of the active record of the primary file;

6. define the physical record following the active one as working record;

7. in case the active record is the last physical record of the file, then the first physical record of the file becomes the working record.

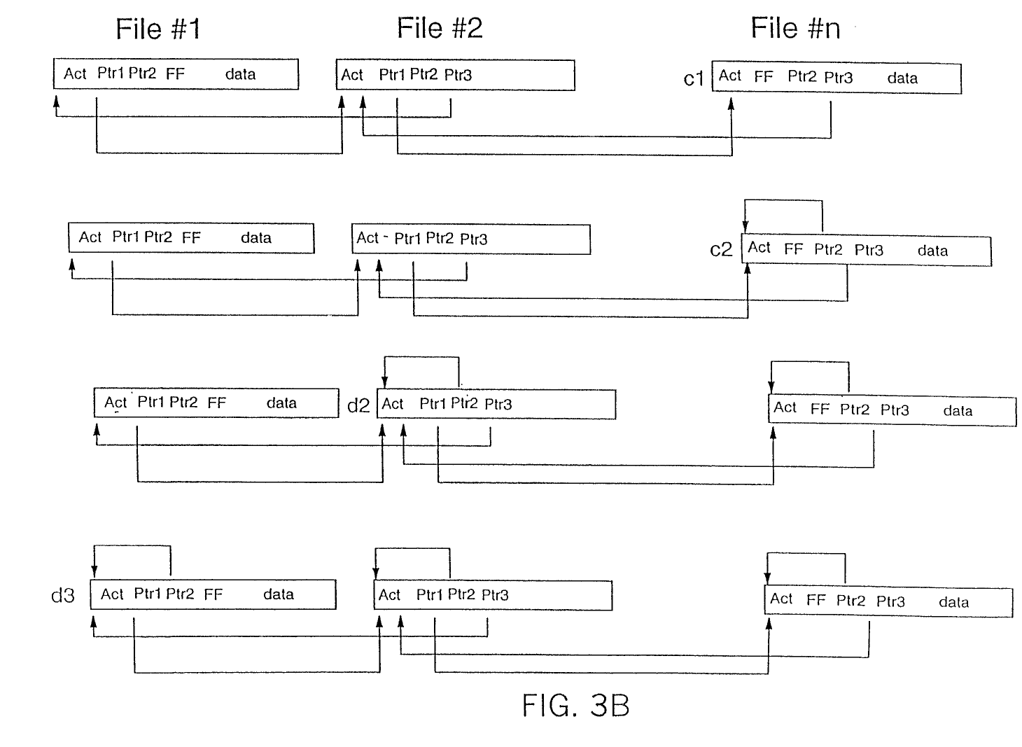

The method described above can be extended to an arbitrary number of files without any changes to the algorithms. In this case, all further files are classified as secondary files. Hereinafter, referring to FIGS. 3a and 3b, the method according to the present invention is explained for an arbitrary number of files, wherein one record in one file has the following structure:

Flag Ptr1 Ptr2 Ptr3 Data

status synch. synch.

The Flag indicates whether a record is active (“A”) or inactive (“I”). A record can have the “A” flag set but still is not considered to be valid: if the Ptr2 field does not point to the beginning of the record, the record is still part of a chain to records in other files and ‘under construction’. Only when Ptr2 points to the beginning of its own record can it be said for sure that the chain has been unlinked and all files are synchronized. A record with this condition and with the flag set to ‘active’ could be called ‘fully active’.

The files are again cyclical files, an arrangement which is often described as a ring buffer. They are record-oriented, in other words, there always is one ‘current record’ from the operating system's point of view. The current record does not have to be the same as the ‘fully active’ record.

The following sequence of events describes how an arbitrary number of files can be updated and at the same time ensure that either the current (old) information in all files remains accessible or the new information is guaranteed to exist in all files. The number of pointers can probably be reduced and the scheme be greatly simplified if we operate only on a well-defined set of files which never changes.

a. Append or update the Data field of a record in the first file:

a1 Append a new record in file 1 (the primary file) and copy the data from the current record to this new record. Modify the data as required. The appended record becomes the current record (from the operating system's point of view). The previous record remains ‘fully active’ (from the safe update mechanism's point of view). [1st write to Ptr2] A power failure at this point still leaves the previous record ‘fully active’. Ptr2 in the current record points at this record because it has been copied in step (a1) from the previous record in this file where it points to the begin of this same previous record.

a2 The new (current) record is flagged ‘inactive’. [1st write to Flag] Step a2 can also be accomplished together with a1 in one write operation.

a3 Ptr1 is set to a value which signals the end of a linked list (no link to a subsequent file) [1st write to Ptr1]

a4 Ptr3 is set to a value which signals the end of a linked list (the first file does not have a link to a previous file) [1st write to Ptr3]. A power failure during this process still finds the previous record as before: fully active, no changes. Any changes to the new (current) record in file 1 remain therefore invisible and are discarded.

b. Append or update the Data field in the second and subsequent files:

b1 Append a new record in this 2nd, 3rd, etc. file and copy the data from the current record to this new record. The appended record becomes the current record. Modify the data as required. The previous record remains ‘fully active’ [1st write to Ptr2]

A power failure at this point still leaves the previous record ‘fully active’. Ptr2 points at this record because it has been copied in step (b1) from the previous record in this file where it also points to the beginning of this previous record.

b2 The new (current) record is flagged ‘inactive’. [1st write to Flag] Step b2 can also be accomplished together with b1 in one write operation.

b3 Ptr1 is set to a value which signals the end of a linked list (no link to a subsequent file) [1st write to Ptr1].

b4 Ptr3 is set to point at the new (current) record in the previous file. This establishes a backward link between the files. [1st write to Ptr3].

We are now done with the new (current) record in this file 2, 3, etc. File 1 and file 2 can still fall back to their previous records which are ‘fully active’. Ptr2 in the current record should make automatic internal backtracking easy, or simply use the options in the Read Record command to address the previous record.

b5 Ptr1 in the new (current) record in the previous file is set to point at the new record in this file. This establishes a forward link from the previous file in the chain to this file. [2nd write to Ptr1]

b6 The flag in the new record in the previous file is set to ‘active’ [2nd write to Flag].

However, Ptr2 of the new record in the previous file still points at the previous record in the previous file. Therefore the new record cannot become ‘fully active’ yet. A power failure during this process still finds the previous records in the file(s) as before: fully active, no changes. Any changes to the new records in these files 2, 3, etc. remain invisible and are discarded.

c. . . . and so on with any additional files until we have appended or updated all data in all files which need to be kept in synchronism. There are some final actions which are unique for the append or update of the (last) file.

c1 Set the Flag field of the last appended (current) record to ‘active’. [2nd write, 1st was ‘inactive’ in step a1 or b1]. We can save this 2nd write if we already know that this is the last file when we append the new record and modify its contents as we copy from the previous record.

A power failure at this point leaves an incomplete chain behind. An incomplete chain (one where the last record in the chain is not marked as ‘active’ AND Ptr2 does not point at the same record) is plainly discarded and we fall back to the ‘fully active’ (previous) records in all files.

c2 Set Ptr2 of the new (current) record to point at the beginning of the current record. This one write makes the new record in the last file ‘fully active’ and enables the recovery. Now we have the previous record in the last file which is ‘fully active’ and the current record which is also ‘fully active’.

A power failure after this single write operation has no adverse effect because we can now recover.

### RECOVERY

We can repair a power failure after step (c1) in two ways: either we can begin again from scratch to update all files; all the previous records still hold the old information and a new attempt to update the files synchronously might just as well succeed this time. When we append new records in the files, then we copy the Ptr2 fields also to the new records which lead us back to the ‘fully active’ record in each file.

Alternatively, it is possible to roll forward and now make all the new (current) records in the chain fully active, which is much more convenient:

d. Check for need to recover from a power failure: Check the primary file #1 if there is a current record which has the ‘active’ flag set AND Ptr2 does not point to the Flag field of the same record. If we find such a record in file 1, then it must have been added in step (a) above. If there is no such record, then we do not have to recover from a power failure.

Recovery, linked list was built successfully

We start from the end of the chain to make the records fully active. The chain becomes shorter with each successful new record activation until Ptr2 in the new (current) record in file 1 points to the Flag field of the same record and is then also ‘fully active’.

Starting with the now ‘fully active’ record found in file 1, follow the chain along the Ptr1 links until Ptr1 signals the end of the chain where the Flag field is marked as ‘active, last in chain’.

d1 If the new (current) record in the last file in the linked list is ‘fully active’, search the file for another fully active record and, if one is found, set the Flag there to ‘inactive’ [3rd write to Flag]. Continue with step (d4) and unlink the file. This was the last file in the original chain, as it has two ‘fully active’ records, or we must have had a failure during recovery between steps (d3) and (d4) after this file was completely done but was still linked to the previous file.

d2 If the new (current) record is ‘active’ but Ptr2 does not point to the beginning of its own record, follow Ptr2 to the previous record in the last file. Check if the previous record is ‘fully active’; if yes, set the Flag there to inactive [3rd write to Flag].

If power fails after this step, then we come to the end of the chain again but notice that we do not have anything to do any more with the previous record.

d3 Modify Ptr2 in the new (current) record in the last file in the chain that it points to the beginning of the same record. [2nd write to Ptr2]. This makes the new (current) record ‘fully active’.

A power failure at this point leaves the new (current) record in the last file flagged as ‘fully active’. When recovery is restarted, it runs into step (d1) and skips (d2, d3, d4).

d4 Unlink the currently last file: set Ptr1 in the previous file (Ptr3 brings us there) to a value which indicates the end of the linked list.

A power failure at this point leaves the linked list shortened by one file. The recovery process can simply begin again, finds the previous file is now the last file, and falls into step (d2).

d5 If power stays on and we continue: Go backwards along the Ptr3 linked list to the previous file and repeat steps (d1, d2, d4, d5) until Ptr3 signals that we are at the beginning of the chain in file 1.

Recovery, linked list was not built successfully

e1 If the new (current) record in the last file in the linked list is active but Ptr2 does not point to the beginning of the record, we may have been interrupted after (a1), (b1) or (c1). Set the flag to ‘inactive’.

A power failure at this point leaves the pointers intact (Ptr2 is needed). We can re-enter the recovery routine and fall into (e2).

e2 If the new (current) record in the last file in the linked list is inactive and Ptr2 does not point to the beginning of the record, we have been interrupted after steps (a2), (b2) or (e1). Otherwise go to step (e5). Now follow Ptr2 to the previous record in this file. We are in the old (previous) record and fall back to its old data. Set Ptr1 to point at the new (current) record. We must be able to find it now. Note: Ptr1 is no longer part of a chain in the old record and can be reused.

A power failure at this point lets us restart and we fall into step (e2) again.

e3 Set the flag in the old record to ‘active, recovered’ to differentiate it from a fully active last record in a chain which is described in steps d1 . . . d5.

A power failure at this point lets us restart the recovery and we fall into (e2) again.

e4 Make this old (previous) record in the last file the current record from the operating system's point of view.

A power failure at this point leaves the linked list with a current record in the last file which is ‘active, recovered’ and Ptr2 points to the beginning of the record. This file has been successfully recovered but we have not unlinked this last file yet.

A power failure at this point means that we re-enter at (e2) and fall through to (e5).

e5 If the old (current) record in the last file in the linked list is ‘active, recovered’ and Ptr2 points to the beginning of this record, then unlink this currently last file from the chain. Follow Ptr1 in the current record of the last file to find the now defunct “new” record which contains a valid Ptr3 with a backward file link. Set Ptr1 in the previous file to a value which indicates the end of the linked list. The previous file is now the ‘last file’. Continue with step (e1) until Ptr1 indicates that we are at the beginning of the linked list file 1.

This method works exactly the same as the one which involves two files, independent of several important criteria:

It is immaterial how many different files are involved and need to be kept in sync.

It is immaterial in which sequence the programmer touches the second, third, etc. files, i.e. how a specified sequence flow defines the order in which parameters are updated.

All that is needed for recovery is the knowledge which file is updated first in such an atomic sequence. Mark a file #1 if there is a record which has the ‘active’ flag set where Ptr2 does not point to the beginning of the same record. If there is no such record, then we do not need to perform any recovery.

The method writes at the most three times to the same addresses (flag).

The following are annotated excerpts from an example of a computer program implementing the method according to the present invention for a purchase sequence. If run on a computer, such a computer program performs the steps of a method according to the present invention.

In this embodiment of the invention, the following abbreviations are used: SAM (Secure Access Module), PSAM (Purchase Secure Access Module, authenticate a chip card when money is debited, keeps track on accumulated purchase amounts), LSAM (Load Secure Access Module, authenticates a chip card when money is loaded on the card, keeps track on accumulated load amounts), PSALM (Combination of PSAM and LSAM), HDR (Header).

1. Atomic sequence flow—Initialize PSAM

Work with file EF_PLOG:

1. Search from the beginning of the file until the first current record (marked active with 01) is found.

2. Mark the following record with 00. This becomes our working record but it remains inactive.

3. Copy all other data fields from the first found record to the working record.

HDR{

EF-PLOG[(1st found curr)+1].curr=‘0’ new record inactive

EF-PLOG[(1st found curr)+1].all other=EF-LOG[1st found curr)].all other copy fields }

Now use the working record in EF_LOG:

Update the fields TRT, MTOT, NT, NIT, NC, NCR in this record as required. This record update operation is handled in the smart card operating system.

EF_PLOG[(1st found curr)+1].TRT=PurchaseInitializedE (we skip the PurInitializeStartedE state!)

EF_PLOG[(1st found curr)+1].MTOT=0

EF_PLOG[(1st found curr)+1].NT=EF_LOG[(curr)].NT+1

EF_PLOG[(1st found curr)+1].NCR=NCR (internal)

EF_PLOG[(1st found curr)+1].NC=EF_TM(NCR)[(curr)].NC+1 logged here

EF_PLOG[(1st found curr)+1].NIT=EF_TM(NCR)[(curr)].NIT+1 logged here

EF_PLOG[(1st found curr)+1].XXXiep=(from command parameters: CURRiep, FLIDiep, BALiep, IDiep, NTip, IDpda,

EF_PLOG[(1st found curr)+1].DATE,TIME=(from command parameters) ID_PDA

The updated record in EF_PLOG has not been activated yet! The NIT increment in EF_TM comes later here in step 1

If power fails before or at this point, then we fall back to the current active record in EF_PLOG and keep the old information—which is still ok. The state is also that of the old record. The process as described above can therefore be initiated again.

If everything went well, proceed in a similar way in EF₁₃ TM(x).

4. Search from the beginning of the file until the first current record (marked active with 01) is found.

5. Mark the following record with 00. This becomes our working record but it remains inactive.

Now use the inactive working record in EF_TM(x)

Copy the already incremented field NIT from the log file.

EF_TM(NCR)[1st found curr)+1]=‘0’ new record inactive

If power fails here, we fall back to the old record in EF_PLOG and in EF_TM. OK.

EF_TM(NCR)[(1st found curr)+1].NIT=EF_LOG[(1st found curr)+1]. NIT counted here

EF_TM(NCR)[(1st found curr)+1].NC=EF_LOG[(1st found curr)+1].NC counted here

The NIT and NT actual counters are incremented now but the record is still inactive.

If power fails at or before this point, then we fall back to the currently active EF_TM record with the old information. This is still ok because we also fall back to the old EF_PLOG record with its old TRT state. However, after EF_PLOG is activated (which is done below) we are forced to activate EF_TM as well.

Note: if we don't activate the EF_TM working record here, then the if statement in Complete Purchase fails. Just for reference, here is how it looks if we activate the EF_TM record right here:

Work with file EF TM(x):

if EF_TM(NCR)[(1st found curr)+1].NIT EF_PLOG[(1st found curr)+1].NIT EF_TM(NCR)[(1st found curr)+1].curr=‘1’ new record active

If power fails here, then we have two active records in EF_TM but hopefully find the same first active (old) record as before. Consider the special case of Wrap-around in the circular file! this means that we still fall back to the old data. OK.

EF_TM(NCR)[(1st found curr)].curr=‘0’ old record inactive

Now we have one active record in EF_TM with the correct NIT which matches EF_PLOG. If power fails here, then the (old) active record in EF_PLOG indicates that we are still in state PurCompletedE or PurAbortCompletedE: we repeat the command “Initialize PSAM for Purchase” with the steps above and start new records in EF_PLOG a and in EF_TM.

The still inactive record in EF_PLOG and the active record in EF_TM are now in sync.

If everything went well, make the new record in EF_PLOG the current record. (Not without doing the same with EF_TM . . . )

TRL{

EF_LOG[(1st found curr)+1].curr=‘1’ new record active

If power fails now, then we have two current =active records. We always look only for the first, i.e. we hope to find the old one.

Consider wrap-around effects in a circular file. We fall back and lose the information in the new record. This is still ok.

EF_LOG[(1st found curr)].curr=‘0’ old record inactive

}

If power fails now, then we find a new active record in EF_PLOG with the TRT state=PurInitializedE and the NT, NIT log values as incremented, and an also active new record in EF_TM with the NIT counter incremented.

Now we cannot fall back to the old information in EF_PLOG any more. We are now forced to either complete or abort the purchase.

2. Atomic sequence flow—Credit PSAM for Purchase

This is another time that the PSAM files are updated. This command can be repeated. Start a new record in EF PLOG for each execution. We enter the command with EF_PLOG and EF_TM values in sync. Work with file EF_PLOG:

1. Search from the beginning of the file until the first current record (marked active with 01) is found.

2. Mark the following record with 00. This becomes our working record but it remains inactive.

3. Copy all other data fields from the first found record to the working record.

HDR{

EF_PLOG[(1st found curr)+1].curr=‘1’ new record inactive

EF_PLOG[(1st found curr)+1].all other =EF_LOG[(1st found curr)+1]. all other copy fields

}

EF_PLOG[(1st found curr)+1].TRT=PurchasingE append record

EF_PLOG[(1st found curr)+1].all other=EF_LOG[(1st found curr)].all other copy fields

EF_PLOG[(1st found curr)+1].MTOT+=MPDA update values

EF_PLOG[(1st found curr)+1].BAL−=MPDA logging

If power fails here, then we lose the purchase amount and remain in the previous sate: PurInitializedE if this was the first Credit Purchase command, PurchasingE if it was an incremental command. In case 1 we must continue with Abort Purchase, in case 2 with Complete Purchase.

Work with file EF_TM(x) (allocate a new working record) EF_TM(NCR)[(1st found curr)+1].TM=EF TM(NCR)[(1st found curr)].TM old value +EF_LOG[(1st found curr)+1].MTOT update

If power fails now, then the amount TM and NIT in the active record in EF_TM are in sync with the active record in EF_PLOG but TM does not include the last purchase amount, only the inactive record reflects this. We could either activate the EF_TM record here—then we have to add MPDA each time. Or we leave the activation to the following commend “Complete Purchase”—then we have to add MTOT here.

There is a current inactive record in EF_PLOG in state PurchasingE with updated MTOT and BAL_IEP fields. Activate it now.

TRL{

EF_PLOG[(1st found curr)+1].curr=‘1’ new record active

If power fails now, then we have two current=active records. We always look only for the first, i.e. we find the old one. We fall back and lose the information in the new record. This is still ok.

EF_PLOG[(1st found curr)].curr=‘0’ old record inactive

}

3. Atomic sequence flow—Complete Purchase

This is the last step where the still disjunct file contents of EF_PLOG and EF_TM need to be brought in sync. The command uses a new record in EF_PLOG to work. The TRT state in the new record in EF_PLOG must be set to PurCompletedE. Check the values in the still inactive new record in EF_TM(x) and activate it.

Work with file EF_PLOG:

1. Search from the beginning of the file until the first current record (marked active with 01) is found.

2. Mark the following record with 00. This becomes our working record but it remains inactive.

3. Copy all other data fields from the first found record to the working record.

HDR{

EF_PLOG[(1st found curr)+1].curr=‘0’ new record inactive

EF_PLOG[(1st found curr)+1].all other=EF_LOG[(1st found curr)].all other copy fields

}

1. Set the final state in the working record of EF_PLOG. This record is still inactive.

2. If the NIT in EF_PLOG is the same as the value in the still inactive working record in EF_TM(x), then update the TM and NIT values in the working record. Otherwise skip this step. Fall back.

3. If the NIT in EF_PLOG is the same as the value in the still inactive working record in EF_TM(x), activate the working record in EF TM(x). Otherwise skip this step. Fall back.

EF_LOG[(1st found curr)+1].TRT=PurchaseCompletedE final state

If power fails, then we fall back to the now active new record in EF_PLOG with state PurchasingE and NIT incremented and the still active old record in EF_TM with NIT not incremented.

Remark: The NIT in the two currently active records in EF_PLOG and EF_TM(x) must be in sync from a previous command “Initialize PSAM for Purchase”. Only TM in EF_TM is left to be updated.

Work with file EF_TM(x)

if EF_TM(NCR)[(1st found curr)+1].NIT==EF_PLOG[(1st found curr)].NIT EF_TM(NCR)[(1st found)+1].TM EF_TM(NCR)[(1st found curr)].TM +EF_LOG[(1st found curr)].MTOT

If power fails here, then we fall back to the still active records in EF PLOG and EF TM and repeat the command. OK.

EF_TM(NCR)[(1st found curr)+1].curr=‘1’ new record active

If power fails here, then we have two active records but hopefully find the same first active (old) record as before. Consider the special case of wrap-around in the circular file! This means that we still fall back to the old data. With these assumptions, the {HDR} makes sure that the second active record is first deactivated again if we execute Complete Purchase another time.

EF_TM(NCR)[(1st found curr)1].curr=‘0’ old record inactive

Now we have one active record in EF_TM with the correct TM and a NIT which matches EF_PLOG. If power fails here, then the (old) active record in EF_PLOG indicates that we are still in state PurchasingE; we repeat the command “Complete Purchase” with the steps above and start a new record in EF_TM.

Activate the working record in EF_PLOG:

TRL{

EF_LOG[(1st found curr)+1].curr=‘1’ new record active

If power fails now, then we have two current=active records. We always look only for the first, i.e. we find the old one. We fall back and lose the TRT state information=PurchasingE in the new record. This is still ok, just repeat the command.

EF_LOG[(1st found curr)].curr=‘0’ old record inactive

}

If power fails here, we have a correct set of data in EF_PLOG and EF_TM(x).

4. Atomic sequence flow—Abort Purchase

This is the last step where the TRT state in EF_PLOG must be set to Pur AbortCompletedE. It is not necessary to synchronize two files since we have activated the new record in the “Initialize PSAM for Purchase” command.

The command uses a new record in EF_PLOG to work.

Work with file EF_PLOG:

1. Search from the beginning of the file until the first current record (marked active with 01) is found.

2. Mark the following record with 00. This becomes our working record but it remains inactive.

3. Copy all other data fields from the found record to the working record.

HDR{

EF_PLOG[(1st found curr)+1].curr=‘0’ new record inactive

EF_PLOG[(1st found curr)+1].all other=EF_LOG[(1st found curr)].all other copy fields

}

1. Set the final state in the working record of EF_PLOG. This record is still inactive

EF_LOG[(1st found curr)+1].TRT=PurAbortCompletedE final state

IF power fails here, then we fall back to the now active new record in EF_PLOG (with state PurInitializedE and NIT incremented) and the still active old record in EF_TM. OK.

Activate the working record in EF_PLOG:

TRL{

EF_LOG[(1st found curr)+1].curr=‘1’ new record active

If power fails now, then we have two current=active records. We always look only for the first, i.e. we find the old one WITH STATE PurInitializedE. We fall back and lose the information in the new record but can repeat the Abort Purchase command. This is still ok.

EF_LOG[(1st found curr)].curr=‘0’ old record inactive

}

If power fails now, we have an active record which reflects the correct counters, etc. in EF_PLOG.

PSALM load sequence

Atomic sequence flow—Debit LSAM

Work with file EF_LLOG:

1. Search from the beginning of the file until the first current record (marked active with 01) is found.

2. Mark the following record inactive with 00. This becomes our working record.

3. Copy all data fields from the active record to the working record.

4. Update the working record.

HDR{

}

EF_LOG[(1st found curr)+1].TRT=LoadedE final state

EF_LOG[(1st found curr)+1].MTOT=MLDA logged here

EF_LOG[(1st found curr)+1].NT=EF_LOG[(1st found curr)].NT+1 logged here

EF_LOG[(1st found curr)+1].NIT=EF_TM(NCR)[(1st found curr)].NIT +1 (logged here)

EF_LOG[(1st found curr)+1].NC=EF TM(NCR)[(1st found curr)].NC+1 (logged here) MWi

EF_LOG[(1st found curr)+1].NCR=NCR

EF_LOG[(1st found curr)+1].XXXiep=(from command parameters)

A power failure finds EF_LLOG updated but TM, NIT, NC in EF_TM (NCR) are not. The command cannot be repeated. We have to fall back to the old data in the active record in EF_LLOG. This is ok.

If everything went well, work with EF_TM(x):

1. Search from the beginning of the file until the first current record (marked active with 01) is found.

2. Mark the following record inactive with 00. This becomes our working record.

3. Copy all data fields from the active record to the working record.

4. Update the working record with data which have already been logged in EF_LLOG

EF_TM(NCR)[(1st found curr)+1].curr=‘0’ new record inactive

EF_TM(NCR)[(1st found curr)+1].NIT=EF_LOG[(1st found curr)+1].NIT counted here

EF_TM(NCR)[(1st found curr)+1].NC=EF_LOG[(1st found curr)+1].NC counted here MWi

EF_TM(NCR)[(1st found curr)+1].TM=EF_TM(NCR)[(1st found curr)+1].TM +MLDA accounted here

If power fails at this point, then we fall back to the currently active record in EF_TM. The working record in EF_LLOG has also not been activated yet, so both files fall back to the old information.

if (EF_TM(NCR)[(1st found curr)+1].NIT==EF_LOG[(1st found curr)+1].NIT)

{

EF_TM(curr/flid)[(1st found curr)+1].curr=‘1’

EF_TM(curr/flid)[(1st found curr)].curr=‘0’

}

TRL{

EF_LOG[(1st found curr)+1].curr=‘1’ new record active

If power fails now, then we have two current =active records. We always look only for the first, i.e. we find the old one. We fall back and lose the information in the new record. This is still ok. EF_LOG[(1st found curr)].curr=‘0’ old record inactive

}

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claim is:

1. A method of securely managing a number of data files in non-volatile storage in order to restore data after abortion of a write operation, the data being stored in a record oriented data structure with each of the records containing a status byte in addition to the data contents, wherein, at all times during the write operation, all of the data files affected by the write operation contain either all of the data stored prior to the write operation, or all of the data as modified subsequent to the write operation.

2. A method as claimed in claim 1, where the or each file affected by a write operation comprises a plurality of records, one of said records in the or each file containing the data prior to said write operation and another of said records being modified according to said write operation, each of said records also comprising a status byte indicative of the status of the data contained therein.

3. A method as claimed in claim 2, wherein said data prior to the write operation, in each file, is retained as the active data in the case of a power failure, until all files have been successfully updated according to said write operation.

4. A method as claimed in claim 1, wherein each record contains a synchronization byte, indicating a relationship with records of other files.

5. A method as claimed in claim 3, wherein each record contains a synchronization byte, indicating a relationship with records of other files.

6. A method as claimed in claim 5, each record comprising a first pointer indicating the current data-containing record of a previous file and a further pointer (PTR 3) indicating the current data-containing record of a subsequent file.

7. A method as claimed in claim 6, comprising a second pointer (PTR 2) indicating the current data-containing record of that file.

8. A method of securely managing EEPROM data files in order to restore data after abortion of a write operation, the data being stored in the files in a record-oriented data structure, such that the data in all files affected by the write operation is consistent with respect to completion of the write operation, and wherein information concerning the status and location of the consistent data is stored in the record oriented data structure together with the data.

9. A method according to claim 8, wherein two or more data files are affected by said write operation, and wherein new or modified data is written into said files in a cyclic manner, wherein each file comprises an indication of the number of records contained in said file and a plurality of records, and wherein each record comprises an indication of the status of the data in said record, a synchronisation number synchronising with records of other files, and said data.

10. A method according to claim 9, comprising determining a current active record of a first of said files, and a working record of said first file; setting the synchronization number of the working record of said file to the synchronization number of the current active record; copying the data stored in said current active record into said working record and adding to or modifying said data according to said write operation, in said working record; changing the status of said working record of said file to ‘active’; repeating said steps for each further file; and changing the record status of said original current active record of said first file to ‘inactive’ as an indication that said write operation is complete.

11. A method as claimed in claim 10, wherein said step of determining the current active record and the working record of said files comprises searching for the first record in said file whose status byte indicates ‘active’ status and setting this record as said current active record, and setting the subsequent record as said working record.

12. A method as claimed in claim 11, comprising: adding to or modifying the data of a record in the first file by:
identifying the current active record of said file and a working record and copying the data to be added to or modified from the current active record to the working record;
modifying the data in said working record in accordance with the write operation; wherein the status byte of said current active record indicates that that record is ‘fully active’ and the status of said working record indicates that that record is ‘inactive’;
setting synchronization indicator pointers to indicate that said file is said first file and to indicate that no further files have been modified;
identifying a current active record and a working record of a second file and copying the data from the current active record to the working record; modifying the data in the working record according to said write operation, wherein the status byte of said active current record indicates that the data in this record is “fully active” and the status byte of the working record indicates that this record is ‘inactive’;
setting synchronization indicator pointers to indicate the link between this file and said first file, and changing said synchronization indicator pointer of said first file to indicate its link with said second file; and
repeating these steps for said second file for any subsequent files, wherein for the last file affected by said write operation, after setting said synchronization indicator pointers, determining that this is the last file, setting an indication pointer to indicate that no subsequent files are affected by said writing operation; and
setting the status byte of each of said working records of said affected files to a ‘fully active’ state, whereupon the write operation is complete and the modified data is the active data in all files.

13. A method as claimed in claim 12, wherein, upon interruption of said write operation at any stage, either all current active records of all files affected by said operation are set as ‘fully active’ records, and the data contained in said files prior to the start of said write operation is the current active data, or all working records of all files are set to a ‘fully active’ status, in which case all files contain the modified data due to said write operation as said active data.

14. A method as claimed in claim 13, wherein interruption of said write operation during or immediately after the step of modifying the data in the working record of said first file results in the current active record of said first file remaining as the ‘fully active’ data record, at which time no further files have been modified and all of the ‘active’ datable files correspond to the data prior to the write operation.

15. A method as claimed in claim 13, wherein an interruption of said write operation during or subsequent to the setting of the synchronization indicator pointers in said first file results in the current active record of said first file remaining as the ‘fully active’ data record, at which time no further files have been modified and all of the ‘active’ datable files correspond to the data prior to the write operation.

16. A method as claimed in claim 13, wherein an interruption of said write operation during or immediately after the step of modifying the data in the second or subsequent files results in the current active record of said second or subsequent file remaining set as said ‘fully active’ record, and, since said synchronization indicator pointer of said first file still indicates that said current active record is still said ‘fully active’ record of said first file, the currently active data of both or all of said files remains as that prior to the start of the write operation.

17. A method as claimed in claim 13, wherein an interruption to said write process during or immediately after modifying the data in the working record of the last file affected by said write operation, results in all of the current active records of all of said files being retained as said fully active records, wherein the currently active data corresponds to the data prior to the write operation.

18. A method as claimed in claim 13, wherein an interruption of said write process during or immediately after modification of the data in the working record of the last file affected by said write operation, causes all working records of all of said files to become set to ‘fully active’ records, such that all files contain data modified as a result of said write operation as the currently active data.

19. A method as claimed in claim 12, wherein, when all of said write steps have been successfully completed, without an interruption, said synchronization indicator pointers are used to indicate the links between the modified records of the files affected, and all working records are set to status ‘fully active’ and said current active records are set to status ‘inactive’.

20. A system for securely managing EEPROM data files so that the data can be restored after abortion of the write operation to said data files, the system comprising an EEPROM, and means for writing data to said EEPROM, said EEPROM comprising a number of data files, each data file comprising a plurality of records in a record oriented data structure.

21. A computer programme arranged such that when it is run on a computer, it executes a secure management of EEPROM data files so that data can be restored after abortion of a write operation, the programme being arranged to execute the steps of claim 1.

22. A computer programme arranged such that when it is run on a computer, it executes a secure management of EEPROM data files so that data can be restored after abortion of a write operation, the programme being arranged to execute the steps of claim 7.

23. A computer programme arranged such that when it is run on a computer, it executes a secure management of EEPROM data files so that data can be restored after abortion of a write operation, the programme being arranged to execute the steps of claim 8.

24. A computer programme arranged such that when it is run on a computer, it executes a secure management of EEPROM data files so that data can be restored after abortion of a write operation, the programme being arranged to execute the steps of claim 13.

25. A computer programme as claimed in claim 21, which is stored on a data carrier medium.
